(19) United States
(12) Patent Application Publication
(10) Pub. No.: US 2008/0237314 A1
(43) Pub. Date: Oct. 2, 2008

(54) Method of joining electronic package capable of prevention for brittle fracture

(76) Inventors: Jin Yu, Yuseong-k (KR); Young-Kun Jee, Yuseong-k (KR); Yong-Ho Ko, Hwaseong-si (KR)

Correspondence Address: THE NATH LAW GROUP, 112 South West Street, Alexandria, VA, 22314, US

(21) Appl. No.: 11/907,528

(22) Filed: Oct. 12, 2007

(30) Foreign Application Priority Data
Mar. 28, 2007 (KR) 10-2007-0030556

(51) Int. Cl. B23K 31/02; B23K 1/00

(52) U.S. Cl. 228/245

(57) ABSTRACT

Disclosed is a method of joining electronic package parts, comprising the steps of: reflowing lead-free solders containing alloy elements on top of each of the electronic package parts having a surface treated with copper or nickel; and mounting the surface treated electronic parts on the lead-free solders then reflowing the lead-free solders to generate intermetallic compound between the lead-free solders and the surface treated portion of each of the electronic parts.

Alternatively, the method of joining the electronic package parts according to the present invention comprises the steps of: forming a plating layer made of alloy elements on top of each of the electronic parts having a surface treated with copper or nickel and reflowing lead-free solders; and mounting the surface treated electronic parts on the lead-free solders then reflowing the lead-free solders to allow the alloy elements contained in the plating layer to be diffused into the lead-free solders and generate intermetallic compound between the lead-free solders and the surface treated portion of each of the electronic parts.

The present invention can prevent brittle fracture of the electronic package parts by deriving alteration of the intermetallic compounds generated from existing lead-free solders when the electronic package parts of electronic devices are solder joined together, thereby ensuring reliability of the electronic devices.

### BACKGROUND OF THE INVENTION

This application claims priority to Korean Patent Application No. 2007-0030556, filed on Mar. 28, 2007, in the Korean Intellectual Property Office, the entire contents of which are hereby incorporated by reference.

1. Field of the Invention

The present invention relates to a method of joining electronic package capable of preventing brittle fracture, more particularly, to a method of joining separate electronic package parts (hereinafter, often referred to as “electronic parts”) for prevention of brittle fracture by using lead-free solders in joining the electronic parts having surfaces treated with copper or nickel, and/or forming a plating layer made of alloy elements on top of each of the electronic parts having a surface treated with copper or nickel then reflowing lead-free solders so as to alter phase of intermetallic compound generated at sites of joining each of the electronic parts and the lead-free solders.

2. Description of the Related Art

In packaging processes of electronic devices, common connection methods such as wire bonding, TAB (tape automated bonding), etc. often reduce electrical signal transfer and connection density of printed circuit boards. In order to solve the problem, flip chips using solders or BGA (ball grid array) connection modes are attracting attention recently.

The most significant requirement of solder joining processes is to ensure thermal, mechanical and electrical reliability by forming a stable intermetallic compound between the solders and an UBM (under bump metallization).

Lead-tin (Pb—Sn) alloy is well known as the representative solder material commonly employed in related applications. However, due to harmfulness and/or potential poisoning, use of lead is regulated and banned in electronic parts. Therefore, there is continuous development in the field of lead-free solders and the prior known Pb—Sn alloys are being replaced by various lead-free solders such as Sn—Ag, Sn—Cu, Sn—Ag—Cu, Sn—Zn, or Sn—Zn—Bi solders. In addition, selection and development of such lead-free solders and appropriate UBM are now underway. Moreover, electrolytic nickel, electroless nickel and copper surface layers are widely used in BGA packages and printed circuit boards.

As described above, highly important requirements for assessing interfacial reaction between lead-free solders and UBM and reliability thereof include inherent properties and forming behaviors of the intermetallic compound generated at the interface. Especially, it requires high resistance against mechanical impact as there is more common use of connection techniques using solders being applied to high performance, high functionality and micro-miniaturized portable electronics.

### SUMMARY OF THE INVENTION

Accordingly, the present invention is directed to solve the problems of conventional techniques as described above and an object of the present invention is to provide a method for prevention of brittle fracture at solder joining sites when joining electronic package parts by using lead-free solders with controlled content of at least one selected from alloy elements such as Zn, Al, Be, Si, Ge, Mg, etc. in conjunction with the electronic parts which were treated with copper or nickel, and/or forming a plating layer made of any one selected from the above elements on a surface of the electronic part and controlling phase variation of an intermetallic compound generated on the copper or nickel surface layer or an under bump metallization UBM.

The present invention describes a method of joining electronic package parts capable of preventing brittle fracture.

According to the present invention, there is provided a method of joining electronic package parts, comprising the steps of: reflowing lead-free solders containing alloy elements on top of each of the electronic package parts having a surface treated with copper or nickel; and mounting the electronic package parts having the surface treated with copper or nickel on the lead-free solders containing alloy elements then reflowing the lead-free solders to generate intermetallic compound between the lead-free solders and the surface treated portion of each of the electronic parts, thereby preventing brittle facture thereof.

According to the present invention, there is also provided a method of joining electronic package parts, comprising the steps of: forming a plating layer made of alloy elements on top of each of the electronic parts having a surface treated with copper or nickel and reflowing lead-free solders; and mounting the electronic parts having the surface treated with copper or nickel on the lead-free solders then reflowing the lead-free solders to allow the alloy elements contained in the plating layer to be diffused into the lead-free solders and generate intermetallic compound between the lead-free solders and the surface treated portion of each of the electronic parts, thereby preventing brittle fracture thereof.

The lead-free solders may have composition of any one selected from Sn—Ag, Sn—Cu and Sn—Ag—Cu based materials.

The alloy elements contained in the lead-free solders and/or in the plating layer may comprise at least one selected from Zn, Al, Be, Si, Ge and Mg.

One of the alloy elements contained in the lead-free solders and/or in the plating layer may be Zn in an appropriate amount of, for example, 0.1 to 9% by weight (abbrev. to “wt. %”).

One of the alloy elements contained in the lead-free solders and/or in the plating layer may be Al in an appropriate amount of, for example, 0.5 to 7 wt. %.

One of the alloy elements contained in the lead-free solders and/or in the plating layer may be Be in an appropriate amount of, for example, 1 to 5 wt. %.

One of the alloy elements contained in the lead-free solders and/or in the plating layer may be Si in an appropriate amount of, for example, 8 to 15 wt. %.

One of the alloy elements contained in the lead-free solders and/or in the plating layer may be Ge in an appropriate amount of, for example, 8 to 15 wt. %.

One of the alloy elements contained in the lead-free solders and/or in the plating layer may be Mg in an appropriate amount of, for example, 1 to 7 wt. %.

The alloy elements contained in the lead-free solders and/or in the plating layer may include 0.1 to 9 wt. % of Zn, 0.5 to 7 wt. % of Al, 1 to 5 wt. % of Be, 8 to 15 wt. % of Si, 8 to 15 wt. % of Ge and/or 1 to 7 wt. % of Mg.

For the electronic part having the surface treated with copper (Cu), there may be generated the intermetallic compound with Cu-M phase at Cu treated portion between the lead-free solders and the electronic part wherein M is at least one selected from the alloy elements including Zn, Al, Be, Si, Ge and Mg.

Likewise, for the electronic part having the surface treated with nickel (Ni), there may be generated the intermetallic compound with Ni-M phase at Ni treated portion between the lead-free solders and the electronic part wherein M is at least one selected from the alloy elements including Zn, Al, Be, Si, Ge and Mg.

The electronic part with Cu treated surface may further have an additional metal layer comprising of gold (Au) or OSP (organic solderability preservative) on top of the Cu treated surface.

Similarly, the electronic part with Ni treated surface may further have an additional metal layer comprising of any one selected from gold (Au), silver (Ag), palladium (Pd) and tin (Sn) on top of the Ni treated surface.

The electronic part may be any one selected from semiconductor chips, package parts and printed circuit boards.

The plating layer made of alloy elements applied on top of the electronic part having Cu or Ni treated surface is preferably formed by commonly used processes such as electro-plating, electroless plating, sputtering, lamination, etc.

Hereinafter, the present invention will be described in detail.

According to the present invention, the joining method of the electronic parts can significantly improve mechanical properties between the lead-free solders and the electronic parts by adding the solders containing appropriate content of at least one selected from alloy elements M such as Zn, Al, Be, Si, Ge, Mg, etc. to a portion of the electronic part which was surface treated with electroless nickel or copper, and/or forming a plating layer made of any one selected from the above alloy elements on top of each of the electronic parts having a surface treated with copper or nickel and reflowing lead-free solders, so that another intermetallic compound is generated instead of inhibiting generation of the intermetallic compound caused without the above alloy elements.

Briefly, the present invention provides the joining method for prevention of brittle fracture when joining the lead-free solders and the copper or nickel surface treated electronic parts, which comprises alteration of contents of the above elements in the lead-free solders or formation of a plating layer formed of any one selected from the above elements so as to control forming behavior of the intermetallic compound generated by the reflowing process and/or phase alteration of UBM, thereby preventing the brittle fracture of the electronic parts.

The electronic parts used in the present invention may comprise any one selected from semiconductor chips, package parts and printed circuit boards. That is, the electronic parts and the joining method thereof according to the present invention can be used in: (1) processes for joining semiconductor chips and package parts; (2) processes for joining package parts; (3) processes for joining package parts and printed circuit boards; and (4) processes for joining semiconductor chips and printed circuit boards, etc.

For the electronic parts with Cu treated surface, Cu-M intermetallic compound needs to be formed, instead of inhibiting generation of Cu₆Sn₅ and Cu₃Sn, by adding an appropriate amount of the elements M to Sn—Ag, Sn—Cu or Sn—Ag—Cu solders or by forming the plating layer made of any one selected from the elements M on the copper surface. As a result, the present inventive method can inhibit production of Cu₆Sn₅ and Cu₃Sn, which are very fragile, and form Cu-M intermetallic compound with high impact resistance, thereby preventing brittle fracture of the electronic parts.

On the other hand, for the electronic parts with Ni treated surface, the present inventive method can prevent spalling of Ni₃Sn₄ intermetallic compound and also inhibit generation of Ni₃Sn₄, Ni₃P and/or Ni₃SnP layers, which are very fragile, on Ni/Au by adding an appropriate amount of the above elements M to Sn—Ag, Sn—Cu or Sn—Ag—Cu solders or by forming the plating layer made of any one selected from the elements M on the nickel surface, thereby remarkably improving mechanical properties of the interface.

The solders used in the present invention which contain the alloy elements M should form Cu-M intermetallic compound for the copper surface and Ni-M intermetallic compound for the nickel surface after the reflowing process. Further, even if the solders have the plating layer made of any one selected from the above elements, Cu-M or Ni-M intermetallic compound should be formed at the interface by introducing the elements contained in the plating layer to the solders during the reflowing process. Composition of the solders based on thermodynamic phase diagram (the composition capable of forming Cu-M or Ni-M intermetallic compound on the basis of the phase diagram) is recommended to be controlled such as, for example: Zn ranging from 0.1 to 9 wt. %; Al ranging from 0.5 to 7 wt. %; Be ranging from 1 to 5 wt. %; Si ranging from 8 to 15 wt. % ; Ge ranging from 8 to 15 wt. % ; and Mg ranging from 1 to 7 wt. %.

Meanwhile, the copper or nickel layer surface treated on the electronic parts may be vapor deposited by commonly used processes such as electro-plating, electroless plating, sputtering, lamination, etc. Top of the copper surface contains any one selected from Au and OSP, while the nickel surface has any one selected from Au, Ag, Pd and Sn formed on top thereof. The metal layer vapor deposited on the top is formed by means of at least one process selected from a group comprising of electroplating, electroless plating, immersion plating, sputtering and evaporation processes.

The alloy elements M may be vapor deposited over the copper or nickel surface by an electro-plating or electroless plating process to form the plating layer. Consequently, the elements M react with Sn—Ag, Sn—Cu or Sn—Ag—Cu solders and are then diffused inside the solders to provide a result substantially equal to that in the case of directly adding the elements to the solders.

Features of the present invention described above and other advantages will be more clearly understood by the following non-limiting examples in conjunction with the accompanying drawings, which are not intended to restrict the scope of the invention.

### BRIEF DESCRIPTION OF THE DRAWINGS

These and other objects, features, and advantages of preferred embodiments of the present invention will be more fully described in the following detailed description, taken in conjunction with the accompanying drawings. In the drawings:

FIG. 1 is perspective views illustrating a process of connecting package parts, which were surface treated with copper or nickel, to a printed circuit board subjected to the same surface treatment according to the present invention: in particular, FIG. 1A shows a step of placing Sn—Ag-M solders 18 (if there is a plating layer made of any one selected from alloy elements M on an electronic part, the solders may not contain the alloy element M) on the printed circuit board 10 and reflowing the solders to generate intermetallic compound 16 between the solders 18 and the copper or nickel metal surface 12 to complete joining thereof, after surface treatment of the printed circuit board with copper or nickel 12 (or formation of a plating layer of any one selected from the alloy elements M on the copper or nickel surface); FIG. 1B shows a step of aligning the package parts or a substrate 20 and the printed circuit board 10 before the connection of the package parts or the substrate with the printed circuit board 10, after surface treatment of the package parts or the substrate 20 connected to the printed circuit board 10 with copper or nickel 12 (or formation of the plating layer made of any one selected from the alloy elements M on the copper or nickel surface) as shown in FIG. 1A; and FIG. 1C shows a step of connecting the printed circuit board 10 and the package parts 20 aligned in FIG. 1B through a reflowing process;

FIG. 2 shows impact test result dependent on varied contents of zinc element in the lead-free solders as an illustrative embodiment of the present invention; in particular, FIG. 2A shows the impact test result for the substrate surface treated with copper; and FIG. 2B shows another impact test result for the substrate surface treated with electroless nickel;

FIG. 3 shows scanning electron micrographs illustrating a cross sectional face at the printed circuit board side of a specimen which was subjected to an impact test after a first reflowing process; in particular, FIG. 3A is a photograph exposing a cross sectional face between the solders with 3 wt. % of zinc content and the copper metal surface, which does not represent Cu₆Sn₅ and has impact number of more than 250; and FIG. 3B is another photograph exposing a cross sectional face between the solders with 7 wt. % of zinc content and the electroless nickel metal surface, which does not represent Ni₃P, Ni₃SnP layer, etc. and has impact number of more than 250;

FIG. 4 shows the impact test result in association with variation of phase or thickness variation of the intermetallic compound, for example, it highlights the fact that generation of the intermetallic compound on the copper or electroless nickel metal surface is inhibited by increasing zinc content of the lead-free solders; in particular, FIG. 4A shows thickness variation of Cu₆Sn₅ intermetallic compound on the copper metal surface in association with the impact test result; FIG. 4B shows a scanning electron micrograph demonstrating broken cross sectional face of Sn-3.5An-1.0Zn solder at the impact number of 170 as set up in FIG. 1A (brittle fracture occurred in Cu₆Sn₅); FIG. 4C shows a graph illustrating correlation of the impact test result and thickness variation of Ni₃P layer on the electroless nickel metal surface; and FIG. 4D shows another scanning electron micrograph demonstrating broken cross sectional face of Sn-3.5An-1.0Zn solder at the impact number of 110 as set up in FIG. 1C (brittle fracture occurred in Ni₃P).

### DETAILED DESCRIPTION OF THE INVENTION

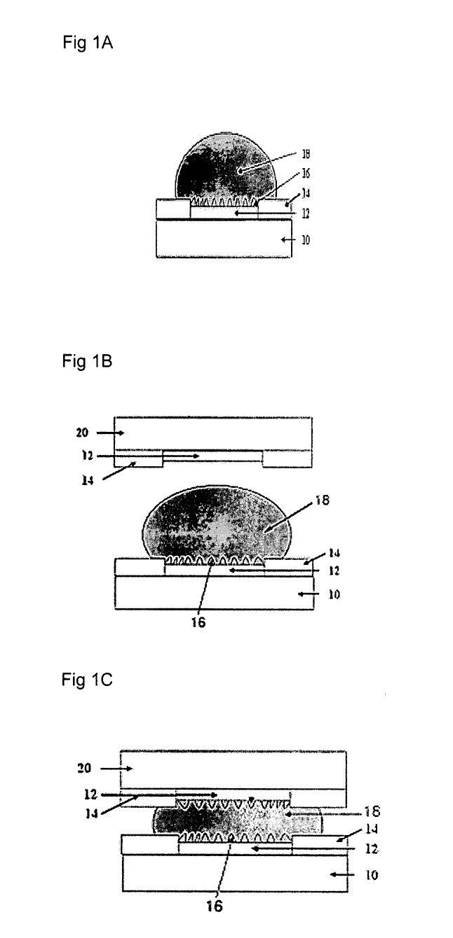

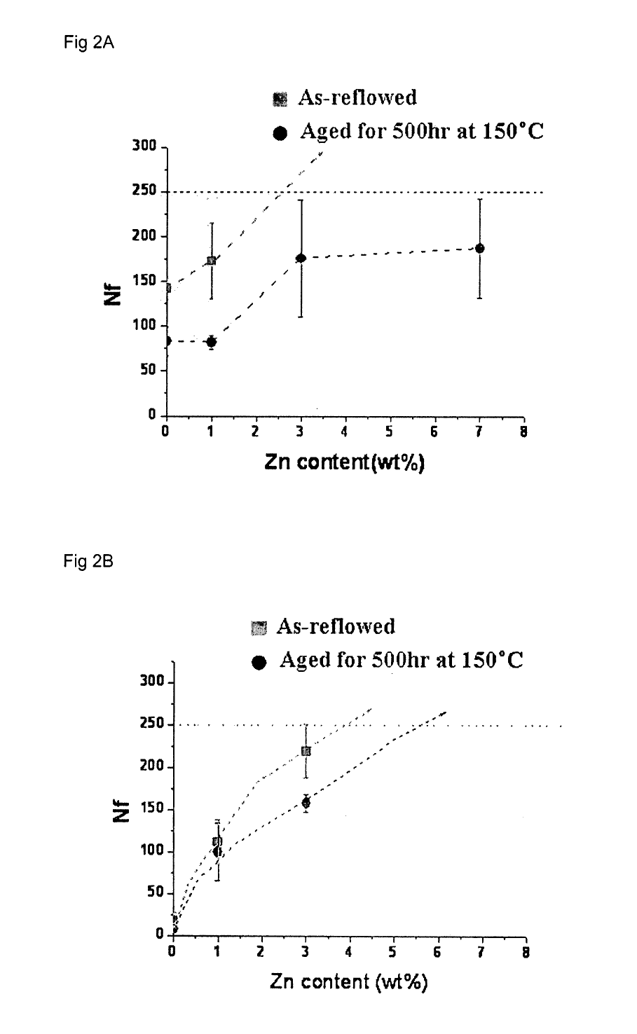

FIG. 1 is schematic views illustrating a process of connecting electronic parts, which are surface treated with copper or nickel layers according to the present invention. The solders used in the above process are Sn—Ag, Sn—Cu or Sn—Ag—Cu solders which have at least one selected from alloy elements such as Zn, Al, Be, Si, Ge and Mg added thereto. Alternatively, any one of the above elements may be vapor deposited on the copper or nickel layer of the electronic part in place of adding the alloy elements to the solders.

Metal surface treatment of a printed circuit board 10 comprises vapor deposition of copper or nickel by means of electro-plating, electroless plating, sputtering or lamination process. Also, any one selected from the above alloy elements can form a plating layer on the copper or nickel surface. After joining the lead-free solders by the reflowing process as shown in FIG. 1A and after aligning the package parts or the substrates 20 which were surface treated with metal materials as shown in FIG. 1B, the electronic parts are connected together by performing the reflowing process for the second time as shown in FIG. 1C. In case of using the copper surface layer in the above process, Cu₆Sn₅ or Cu₃Sn intermetallic compound is formed if the solders do not contain the alloy elements M. But when the solders contain the alloy elements, Cu-M intermetallic compound is obtained. Similarly, in case of using the nickel surface layer, Ni₃Sn₄ intermetallic compound is formed if the solders do not contain the alloy elements M. Moreover, the compound may display brittle fracture readily caused by spalling of the compound. However, if the alloy elements are added to the solders, Ni-M intermetallic compound is formed along with Ni₃Sn₄ intermetallic compound. Further, Ni(P)/Au layer can inhibit production of Ni₃P and Ni₃SnP and significantly improve mechanical reliability of the connection of the electronic parts.

The lead-free solders used in the present invention comprise solders with the recommended composition. That is, content of the alloy elements M can be controlled on the copper surface to inhibit generation of Cu₆Sn₅ or Cu₃Sn intermetallic compound. For use of the nickel surface, an appropriate amount of alloy elements M is added to the solders in order to inhibit generation of Ni₃Sn₄, Ni₃P and Ni₃SnP layer. Alternatively, formation of a plating layer over the copper or nickel surface layer can result in an effect substantially equal to that of the solders treated by adding any one of the above elements to the solders.

FIGS. 1A to 1C show the joining of the package parts and the printed circuit board. However, the present invention is also applicable to other cases in addition to the above joining such as joining of electronic parts, for example: (1) processes for joining semiconductor chips and package parts; (2) processes for joining package parts; (3) processes for joining package parts and printed circuit boards; and (4) processes for joining semiconductor chips and printed circuit boards, etc.

In FIG. 1, a symbol 12 indicates the copper or nickel surface (or the surface with a plating layer formed of any one selected from the alloy elements), a symbol 14 indicates a solder mask, 16 is the intermetallic compound and 18 indicates Sn—Ag-M solders (if only a plating layer is formed on the substrate, M may be ignored).

FIG. 2 shows graphs illustrating impact test results (impact number of breaking) depending on content of zinc in the lead-free solders as illustrative embodiments of the present invention. FIG. 2A shows the impact test result for the copper metal surface of the substrate and, especially, the noticeably improved impact reliability with addition of more than 3 wt. % of zinc. This is because more than 3 wt. % of zinc content inhibited generation of Cu₆Sn₅ intermetallic compound at the interface. Furthermore, it was found that the impact reliability is generally reduced by thermal treatment for a long duration since the intermetallic compound continues to grow during the thermal treatment. FIG. 2B shows another impact test result for the electroless nickel metal surface of the substrate and, especially, noticeably improved impact reliability with addition of more than 1 wt. % of zinc. This is because generation of Ni₃Sn₄, Ni₃P and Ni₃SnP layer was considerably inhibited at the interface by the addition of zinc.

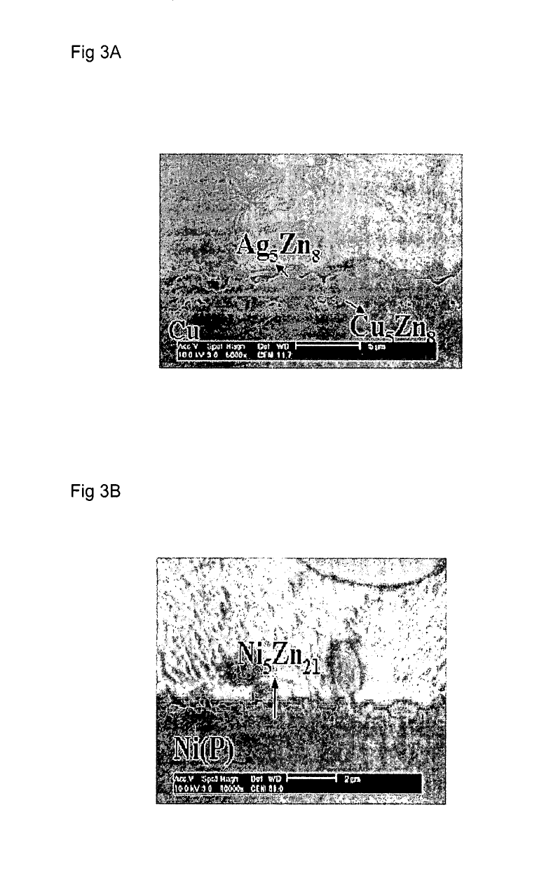

FIG. 3A shows a scanning electron micrograph illustrating the intermetallic compound on the copper metal surface which was generated by the reflowing reaction of Sn-3.5Ag-3Zn. From this figure, it can be seen that no breaking or fracture occurred during the impact test. That is, it was demonstrated that the impact reliability is significantly improved by formation of Zn containing intermetallic compound rather than inhibition of Cu₆Sn₅ generation.

FIG. 3B shows another photograph illustrating reaction of Sn-3.5Ag-7Zn on the electroless nickel metal surface. From this figure, it can be seen that Ni₃Sn₄, Ni₃P or Ni₃SnP layer was not formed and only Ni₅Zn₂₁ intermetallic compound was generated. Also, it was demonstrated that no breaking or fracture occurred during the impact test. Accordingly, the impact reliability can be greatly improved by completely inhibiting generation of Ni₃Sn₄, Ni₃P and Ni₃SnP layers, which are very fragile.

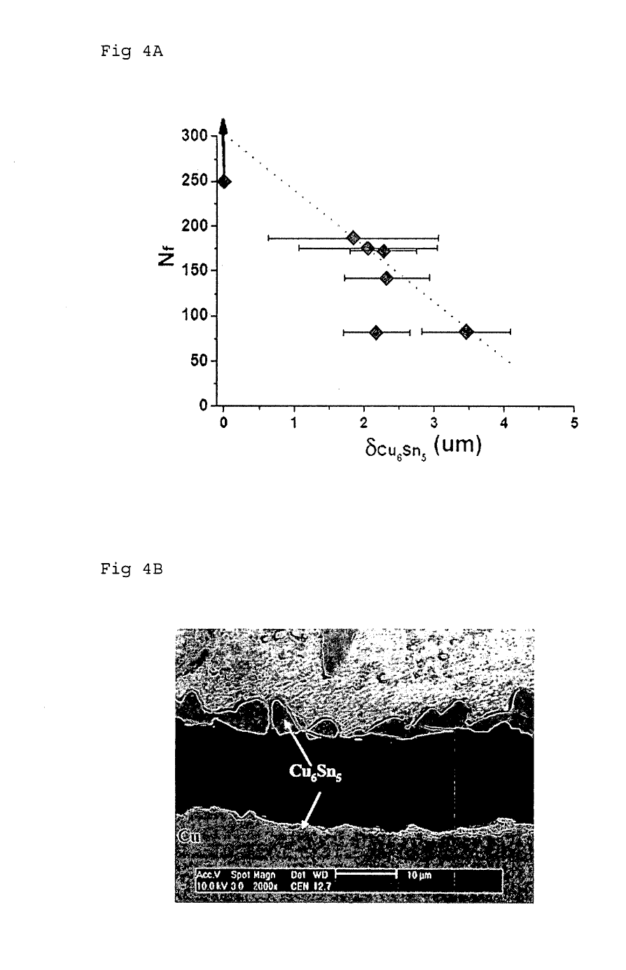

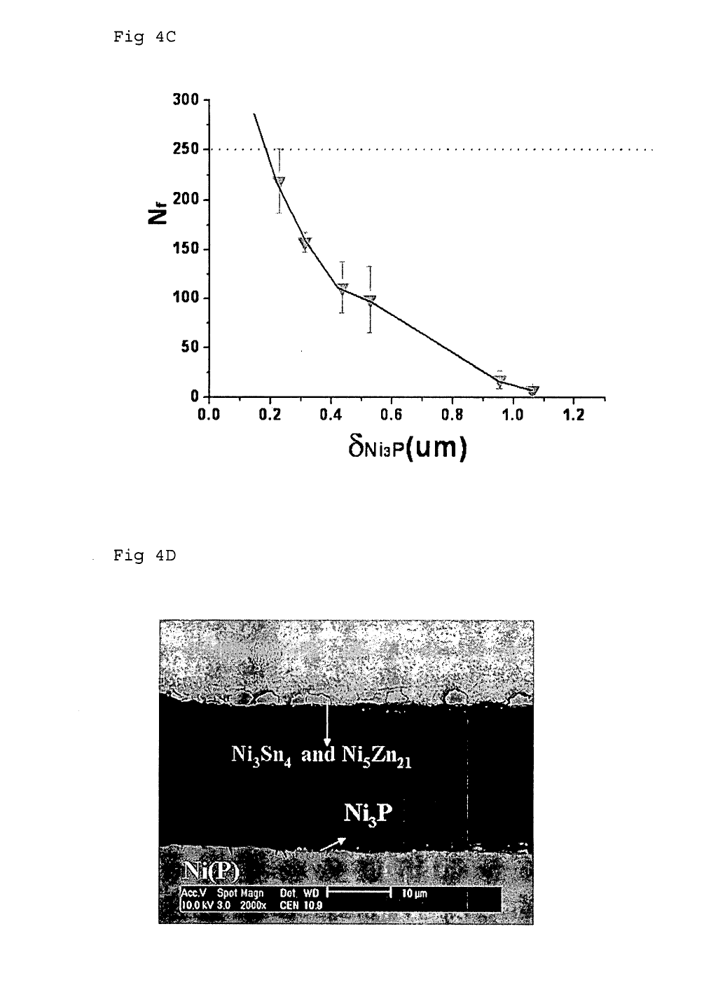

FIG. 4A shows thickness variation of Cu₆Sn₅ intermetallic compound on the copper metal surface in association with the impact reliability on the fact that thickness of Cu₆Sn₅ intermetallic compound was decreased by increasing zinc content. As a result, it was demonstrated that as the thickness of Cu₆Sn₅ intermetallic compound was reduced, the impact reliability was linearly improved.

FIG. 4B shows a scanning electron micrograph displaying brittle fracture which occurred in Cu₆Sn₅ during the impact test. That is, it highlights the fact that it is important to inhibit generation of Cu₆Sn₅ between the solders and Cu UBM by appropriately controlling an amount of the alloy element such as zinc, in order to prevent brittle fracture.

FIG. 4C shows a graph illustrating correlation of the impact reliability and thickness variation of Ni₃P layer on the electroless nickel metal surface on the fact that thickness of Ni₃P layer was decreased by increasing zinc content. As a result, it was demonstrated that as the thickness of Ni₃P layer was reduced, the impact reliability was significantly improved.

FIG. 4D shows another scanning electron micrograph demonstrating that the brittle fracture occurred between the intermetallic compound and Ni₃P layer during the impact test. From this figure, it can be clearly understood that the brittle fracture can be prevented by adding the alloy element such as zinc to inhibit Ni₃P generation.

As described in detail above, the present invention is effective to ensure reliability of electronics by deriving alteration of intermetallic compounds generated in existing lead-free solders which occur in the process of solder joining electronic parts so as to exclude causes and/or origins of the brittle fracture beforehand.

While the present invention has been described with reference to the accompanying drawings, it will be understood by those skilled in the art that various modifications and variations may be made therein without departing from the scope of the present invention as defined by the appended claims.

What is claimed is:

1. A method of joining separate electronic packaging parts capable of preventing brittle fracture, comprising the steps of: reflowing lead-free solders containing alloy elements on top of each of the electronic package parts having a surface treated with copper or nickel; and mounting the electronic package parts having the surface treated with copper or nickel on the lead-free solders containing alloy elements so as to generate intermetallic compound between the lead-free solders and the surface treated portion of each of the electronic parts.

2. A method of joining separate electronic packaging parts capable of preventing brittle fracture, comprising the steps of: forming a plating layer made of alloy elements on top of each of the electronic parts having a surface treated with copper or nickel then reflowing lead-free solders; and mounting the electronic parts having the surface treated with copper or nickel on the lead-free solders then reflowing the lead-free solders to allow the alloy elements contained in the plating layer to be diffused into the lead-free solders and generate intermetallic compound between the lead-free solders and the surface treated portion of each of the electronic parts.

3. The method according to claim 1, wherein the lead-free solders are any one selected from Sn—Ag, Sn—Cu and Sn—Ag—Cu.

4. The method according to claim 1, wherein the alloy elements are any one selected from a group comprising of Zn, Al, Be, Si, Ge and Mg.

5. The method according to claim 1, wherein the alloy elements included in the lead-free solders and/or the plating layer and contents thereof comprise: 0.1 to 9 wt. % of Zn; 0.5 to 7 wt. % of Al; 1 to 5 wt. % of Be; 8 to 15 wt. % of Si; 8 to 15 wt. % of Ge; and 1 to 7 wt. % of Mg.

6. The method according to claim 1, wherein, in case of the electronic part having the surface treated with copper (Cu), there is generated an intermetallic compound with Cu-M phase at Cu treated portion between the lead-free solders and the electronic part wherein M is at least one selected from the alloy elements including Zn, Al, Be, Si, Ge and Mg.

7. The method according to claim 1, wherein, in case of the electronic part having the surface treated with nickel (Ni), there is generated an intermetallic compound with Ni-M phase at Ni treated portion between the lead-free solders and the electronic part wherein M is at least one selected from the alloy elements including Zn, Al, Be, Si, Ge and Mg.

8. The method according to claim 1, wherein the electronic part with Cu treated surface further has an additional metal layer comprising of gold (Au) or OSP (organic solderability preservative) on top of the Cu treated surface.

9. The method according to claim 1, wherein the electronic part with Ni treated surface further has an additional metal layer comprising of any one selected from gold (Au), silver (Ag), palladium (Pd) and tin (Sn) on top of the Ni treated surface.

10. The method according to claim 1, wherein the electronic part is any one selected from semiconductor chips, package parts and printed circuit boards.

11. The method according to claim 2, wherein the plating layer made of alloy elements applied on top of the electronic part with Cu or Ni treated surface is formed by any one selected from electroplating, electroless plating, sputtering and lamination.
